(19) United States
(12) Patent Application Publication
(10) Pub. No.: US 2016/0131146 A1
(43) Pub. Date: May 12, 2016

(54) PRESSURE SENSOR SYSTEM FOR CALCULATING COMPRESSOR MASS FLOW RATE USING SENSORS AT PLENUM AND COMPRESSOR ENTRANCE PLANE

(71) Applicant: General Electric Company, Schenectady, NY (US)

(72) Inventors: Hua Zhang, Greer, SC (US); Douglas Scott Byrd, Greer, SC (US); Steven Craig Castellaw, Greenville, SC (US); Michael James Gutta, Greenville, SC (US); John Nathan Ihme, Greenville, SC (US); Amy Ann Lindblad, Milwaukee, WI (US)

(21) Appl. No.: 14/535,520

(22) Filed: Nov. 7, 2014

(51) Int. Cl. F04D 27/00; F04D 29/40; F02C 3/04

(52) U.S. Cl. CPC F04D 27/001; F02C 3/04; F04D 29/403

(57) ABSTRACT

A pressure sensor system for a compressor including an inlet bellmouth is disclosed. The system includes a first static pressure sensor positioned within a plane of a plenum that is upstream of the inlet bellmouth; and a second static pressure sensor positioned at an entrance plane of the compressor. A mass flow rate calculator may calculate a mass flow rate based on a pressure differential between the plane of the plenum and the entrance plane of the compressor.

### BACKGROUND OF THE INVENTION

The disclosure relates generally to compressors, and more particularly, to a pressure sensor system for calculation of compressor mass flow rate using sensors at a plenum and an entrance plane of the compressor. A mass flow rate calculator and a gas turbine system incorporating the same are also disclosed.

Airflow inlets to industrial devices such as gas turbine compressors include an inlet bellmouth that acts to collect, initially compress, and direct an airflow, e.g., toward a rotating portion of the compressor. In many settings, during operation, total and static pressure is measured in the inlet bellmouth, for example, using a Pitot method. The total and static pressure measurement is used to determine a mass flow rate of air which is used to better control operation of other components, for example, controlling a firing temperature of a combustor of a gas turbine. In another example, mass flow rate may be used to determine a compressor operating limit and its degradation.

One challenge is that Pitot tubes measurement of total and static pressure in the compressor inlet bellmouth and the related mass flow rate calculation method can be inaccurate. For example, the conventional mass flow rate methodology requires, inter alia, accurate knowledge of an inlet annulus area where the total and static pressure is measured. However, conventional inlet bellmouths are oftentimes manufactured as a cast component having significant variation and large tolerances in an internal surface thereof, i.e., they are uneven or rough, making an accurate annulus area indeterminable. In addition, the Pitot tubes must also be presented in the flow path, which increases complexity of the system, and hence, increases inaccuracy and costs.

### BRIEF DESCRIPTION OF THE INVENTION

A first aspect of the disclosure provides a pressure sensor system for a compressor including an inlet bellmouth, the system comprising: a first static pressure sensor positioned within a plane of a plenum that is upstream of the inlet bellmouth; and a second static pressure sensor positioned at an entrance plane of the compressor.

A second aspect of the disclosure provides a mass flow rate calculator for a compressor that includes an inlet bellmouth, the system comprising: a first static pressure sensor positioned within a plane of a plenum that is upstream of the inlet bellmouth; a second static pressure sensor positioned at an entrance plane of the compressor; and a mass flow rate calculator for calculating a mass flow rate based on a pressure differential between the plane of the plenum and the entrance plane of the compressor.

A third aspect of the disclosure provides a gas turbine system comprising: a gas turbine including a combustor; a compressor providing a compressed airflow to the combustor, the compressor including an inlet guide vane and an inlet bellmouth; a mass flow rate calculator for a compressor, the mass flow rate calculator including: a first static pressure sensor positioned within a plane of a plenum that is upstream of the inlet bellmouth, and a second static pressure sensor positioned at an entrance plane of the compressor; a mass flow rate calculator for calculating a mass flow rate based on a pressure differential between the plane of the plenum and the entrance plane of the compressor; and a gas turbine controller controlling a firing temperature of the combustor based on the mass flow rate.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a partial cross-section schematic block diagram of a pressure sensor system, a mass flow rate calculator and/or a gas turbine system according to embodiments of the invention.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, the disclosure provides a pressure sensor system for a compressor including an inlet bellmouth. The system includes a first static pressure sensor positioned at a plenum that feeds an airflow to the inlet bellmouth; and a second static pressure sensor positioned at an entrance plane of the compressor. In contrast to conventional methodology, a mass flow rate calculator may calculate a mass flow rate based on a pressure differential between the plane of the plenum and the entrance plane of the compressor. A gas turbine system may employ the mass flow rate calculator as part of a gas turbine controller to control a firing temperature of a combustor. Although the teachings of the invention will be described as applied to a gas turbine setting, it is understood that pressure sensor system 100 and mass flow rate calculator 132 may be employed in a wide variety of other industrial settings employing a compressor.

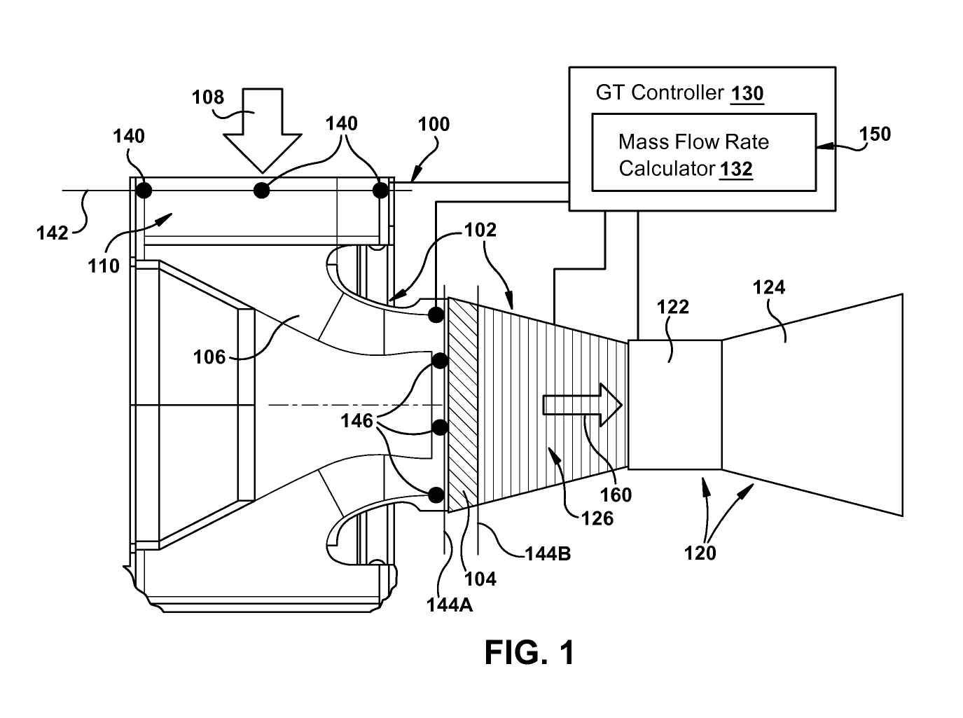

FIG. 1 shows a partial cross-section schematic of a pressure sensor system 100 according to embodiments of the invention. As will be described by way of illustration, pressure sensor system 100 is applied relative to a compressor 102 having an inlet bellmouth 106. Compressor 102 may also include an inlet guide vane 104. As understood, compressor 102 includes a plurality of movable blades 126 that act to pull and axially compress an airflow 108, which may be used for other industrial purposes such as feeding a combustor 122. Inlet bellmouth 106 receives airflow 108 via a plenum 110 from the surrounding environment, and acts to handle airflow 108. Plenum 110 may include any chamber immediately upstream of inlet bellmouth 106 through which airflow 108 passes. An entrance plane 144A, 144B of compressor 102 may be defined as an entrance plane of inlet guide vane 104, where one is provided. Inlet guide vane (IGV) 104 includes a number of movable stator blades (not shown individually) that act to control the capacity of the compressor prior to the inlet of blades 126 that actively compress the airflow. In another embodiment, entrance plane 144A, 144B may be defined as a plane aligned with the inlet of blades 126 (right edge of IGV 104, as illustrated). In the setting illustrated, blades 126 act to more fully compress airflow 108 prior to feeding to a combustor 122 where it is mixed with a fuel and combusted prior to entry into a gas turbine 124 in a known fashion. As such, compressor 102 may be part of a gas turbine system 120 that also includes, inter alia, combustor 122 or turbine 124. A mass flow rate of airflow 108 is one factor that determines a firing temperature within combustor 122.

A gas turbine (GT) controller 130 acts to control, inter alia, compressor 102, i.e., IGV 104 and/or blades 126, to control the mass flow rate of airflow 108 and, consequently, a firing temperature of combustor 122. As understood, GT controller 130 may also control a number other operational parameters of gas turbine system 120. A mass flow rate calculator 132, as will be described herein, acts to calculate a mass flow rate of airflow 108, and may be provided as part of GT controller 130 or as a separate structure communicative with GT controller 130.

Pressure sensor system 100 provides pressure readings from selected points within compressor 102 in order for mass flow rate calculator 132 to calculate a mass flow rate Q of airflow 108. In accordance with embodiments of the invention, and in contrast to conventional methods, pressure sensor system 100 includes a first static pressure sensor 140 positioned within a plane 142 of plenum 110 that is upstream of inlet bellmouth 106, and a second static pressure sensor 146 positioned at an entrance plane 144A, 144B of compressor 102, e.g., at entrance to IGV 104 (144A) or entrance to blades 126 (144B). Plane 142 of plenum 110 may be defined as any plane within plenum 110 upstream of inlet bellmouth 106, e.g., a plane immediately or slightly upstream and perpendicular to the axis of inlet bellmouth 106 such that the location is prior to the rapid acceleration of inlet air in the inlet bellmouth. Since plenum 110 and/or entrance plane 144A, 144B is/are manufactured with a smooth interior and with a substantially uniform surface, an annulus area thereof is readily determinable. In particular, an area Aₚₗₑₙᵤₘ of plenum 110 is readily determinable, and may be used to calculate mass flow rate Q. As a result, the challenges facing determining annulus area of cast, rough internal surface of inlet bellmouth 106 are avoided. Consequently, as will be described, using a different mass flow rate calculation methodology, a more accurate mass flow rate can be calculated. Entrance plane 144A, 144B of compressor 102 may be any plane immediately upstream of compressor 102, e.g., within approximately 10-30 centimeters of IGV 104, prior to where IGV 104 acts on the airflow (plane 144A); or within approximately 10-30 centimeters of an entrance to blades 126 (plane 144B). In the former case, entrance plane 144A may be substantially aligned with a compressor inlet flange (at left edge of IGV 104).

In embodiments, each sensor 140, 146 may include a plurality of static pressure sensors 140, 146 (e.g., 2, 3, etc., but only 3-4 shown for each for clarity). In one embodiment, first static pressure sensors 140 may be substantially non-uniformly arranged about plane 142 of plenum 110, e.g., to achieve good representation of average static pressure. As illustrated, three sensors 140 may be non-uniformly positioned about plane 142 of plenum 110, i.e., with non-uniform circumferential spacing. Alternatively, first static pressure sensors 140 may be substantially uniformly arranged about plane 142 of plenum 110, e.g., about a periphery of plenum 110 to capture a good representation of average static pressure. In this case, the three sensors 140 illustrated may be part of a four sensor set (one removed due to cross-section) such that they are uniformly positioned about plane 142 of plenum 110, i.e., with uniform circumferential spacing. In another alternative embodiment, first static pressure sensors 140 may be positioned about plane 142 of plenum 110 based on a computational fluid dynamic (CFD) simulation, e.g., that may identify optimal locations for determining a static pressure. Similar positioning may be provided for second static pressure sensors 146 about entrance plane 144A or 144B.

Static pressure sensor(s) 140, 146 may include any wall type, insert tube, static tip and trail tail types. However, other now known or later developed static pressure sensor may also be employed that are appropriate for the environment in which they are positioned. In contrast to conventional systems, sensors 140, 146 need not be positioned in the flow path, like Pitot tubes, which reduces the complexity of the system. In one embodiment, pressure sensors 140, 146 may be measured together as differential type sensor, meaning, the sensor reading is relative to each other as pressure drop from planes 142, 144A/144B. Each sensor 140, 146 measures only static pressure, not total pressure.

With further reference to mass flow calculator 132, in accordance with embodiments of the invention, calculator 132 may calculate mass flow rate Q of flow 108 through compressor inlet 106 based on a pressure differential between plane 142 of plenum 110, i.e., as measured by first sensor(s) 140, and entrance plane 144 of IGV 104, i.e., as measured by second sensor(s) 146. More specifically, mass flow rate may be calculated according to the following simpler, yet more accurate, equation:

Q=K(R_{ed})*Aₚₗₑₙᵤₘ*\sqrt{2ρΔP},
where Q is the mass flow rate and may be stated in terms of, e.g., kilograms per second (kg/s),
K (R_{ed}) is a calibrated flow coefficient as a function of Reynolds number,
ρ is air density and may be stated in terms of, e.g., kilograms per cubic meter (kg/m³),
ΔP is static pressure differential of plane 142 of plenum (first sensor(s) 140) and entrance plane 144 of IGV 104 (second sensor(s) 146) and may be stated in terms of, e.g., Pascals (Pa), and

Aₚₗₑₙᵤₘ is the (annulus) area of plane 142 of plenum 110 and may be stated as square meters (m²). Air density p may be calculated using any now known or later developed methodology based on air temperature and pressure. As stated previously, due to the manufacturing of plenum 110 providing a substantially uniform surface with the plenum, area Aₚₗₑₙᵤₘ is readily determinable, and thus provides a more accurate determination of mass flow rate using the simplified, yet more accurate calculation provided. Coefficient K (R_{ed}) may be calibrated for a particular compressor arrangement as long as all the dimensions are defined, i.e., by the same drawings. Under such conditions, the coefficient K (R_{ed}) can be determined based on Reynolds number (R_{ed}), which is the ratio of inertial forces to viscous forces and quantifies the relative importance of these two forces for a given flow condition. This calculation is possible, fundamentally, because the flow resistance that causes pressure drop is correlated to Reynolds number.

Embodiments of the invention may also include a mass flow rate system 150 for compressor 102 having inlet bellmouth 106. System 150 may be used in conjunction with gas turbine system 120, or may be used as a standalone system for any industrial compressor 102. Mass flow rate system 150 may include first static pressure sensor(s) 140 positioned at plane 142 of plenum 110 to inlet bellmouth 106 and a second static pressure sensor 146 positioned at entrance plane 144A of IGV 104 or plane 144B of blades 126. System 150 also may include mass flow rate calculator 132 (outside of a GT controller 130) for calculating mass flow rate Q based on a pressure differential between plane 142 of plenum 110 and entrance plane 144A or 144B of compressor 102, as described herein.

In another embodiment of the invention, gas turbine (GT) system 120 may include gas turbine 124 including combustor 122, and compressor 102 providing compressed airflow 160 to combustor 122. Compressor 102 may include inlet bellmouth 106. GT system 120 may also include mass flow rate system 150, as described herein as part of GT controller 130 for controlling a firing temperature of combustor 122 based on mass flow rate Q in any known fashion. In one embodiment, mass flow rate calculator 132 may be integral with GT controller 130. Alternatively, mass flow rate calculator 132 may be a separate system that communicates with GT controller 130.

The above-described embodiments provide higher accuracy of mass flow rate calculation, and consequently, better control of an industrial machine that relies on the mass flow rate, e.g., a combustor and/or a gas turbine. Despite the simplification of the calculation, a standard deviation error may be, for example, about 0.52% compared to 2.23% for conventional Pitot tube approaches. In the gas turbine setting, the use of mass flow rate calculation as described herein, provides a more durable gas turbine and/or higher power output with lower heat rate. In addition, teachings of the invention provide a less expensive system in that Pitot tubes used in conventional systems can be eliminated. Further, no sensors need penetrate into the flow path, which reduces complexity.

GT controller 130 and/or mass flow rate calculator 132 may be embodied as or within any now known or later developed industrial computer control, and may be embodied as a system, method or computer program product. Accordingly, GT controller 130 and/or mass flow rate calculator 132 may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in any tangible medium of expression having computer-usable program code embodied in the medium. Any combination of one or more computer usable or computer readable medium(s) may be utilized. Embodiments of the present invention are described herein with reference to the block diagram of FIG. 1. It will be understood that each block of the block diagram, and sub-steps commensurate with the conventional functioning of blocks in the block diagram, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts, inter alia, specified in the description, and provided to operational components of the components described, e.g., IGV 104, compressor 102 controls for blades 126, combustor 122, GT 124, etc.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A pressure sensor system for a compressor including an inlet bellmouth, the system comprising:
a first static pressure sensor positioned within a plane of a plenum that is upstream of the inlet bellmouth; and
a second static pressure sensor positioned at an entrance plane of the compressor.

2. The pressure sensor system of claim 1, wherein the first static pressure sensor includes a plurality of sensors that are substantially non-uniformly arranged about the plane of the plenum.

3. The pressure sensor system of claim 1, wherein the first static pressure sensor includes a plurality of sensors that are substantially uniformly arranged about the plane of the plenum.

4. The pressure sensor system of claim 1, wherein the first static pressure sensor includes a plurality of sensors and a position of each of the plurality of sensors about the plane of the plenum is based on a computational fluid dynamic simulation.

5. The pressure sensor system of claim 1, wherein the first static pressure sensor includes a plurality of sensors and each sensor includes a differential type sensor.

6. The pressure sensor system of claim 1, further comprising a calculator for calculating a mass flow rate of a flow through the compressor inlet based on a pressure differential between the plane of the plenum and the entrance plane of the compressor.

7. The pressure sensor system of claim 6, wherein the mass flow rate is calculated according to the following equation:
Q=K (R_{ed})*Aₚₗₑₙᵤₘ*\sqrt{2ρΔP},
where Q is the mass flow rate, K (R_{ed}) is a calibrated flow coefficient as a function of Reynolds number, ρ is air density, ΔP is static pressure differential of the plane of the plenum and the entrance plane of the compressor, and Aₚₗₑₙᵤₘ is area of the plane of the plenum.

8. The pressure sensor of claim 1, wherein the compressor further includes an inlet guide vane, and the entrance plane of the compressor is substantially aligned with an entrance plane of the inlet guide vane.

9. A mass flow rate calculator for a compressor that includes an inlet bellmouth, the system comprising:
a first static pressure sensor positioned within a plane of a plenum that is upstream of the inlet bellmouth;
a second static pressure sensor positioned at an entrance plane of the compressor; and
a mass flow rate calculator for calculating a mass flow rate based on a pressure differential between the plane of the plenum and the entrance plane of the compressor.

10. The mass flow rate calculator of claim 9, wherein the first static pressure sensor includes a plurality of sensors that are substantially uniformly arranged about the plane of the plenum.

11. The mass flow rate calculator of claim 9, wherein the first static pressure sensor includes a plurality of sensors and a position of each of the plurality of sensors about the plane of the plenum is based on a computational fluid dynamic simulation.

12. The mass flow rate calculator of claim 9, wherein the first static pressure sensor includes a plurality of sensors and each sensor includes a differential type sensor.

13. The mass flow rate calculator of claim 9, wherein the mass flow rate is calculated according to the following equation:
Q=K(R_{ed})*Aₚₗₑₙᵤₘ*\sqrt{2ρΔP},
where Q is the mass flow rate, K (R_{ed}) is a calibrated flow coefficient as a function of Reynolds number, ρ is air density, ΔP is static pressure differential of the plane of the plenum and the entrance plane of the inlet guide vane, and Aₚₗₑₙᵤₘ is area of the plane of the plenum.

14. The mass flow rate calculator of claim 9, wherein the compressor further includes an inlet guide vane, and the entrance plane of the compressor is substantially aligned with an entrance plane of the inlet guide vane.

15. A gas turbine system comprising:
a gas turbine including a combustor;
a compressor providing a compressed airflow to the combustor, the compressor including an inlet guide vane and an inlet bellmouth;
a mass flow rate calculator for a compressor, the mass flow rate calculator including:
a first static pressure sensor positioned within a plane of a plenum that is upstream of the inlet bellmouth, and
a second static pressure sensor positioned at an entrance plane of the compressor;
a mass flow rate calculator for calculating a mass flow rate based on a pressure differential between the plane of the plenum and the entrance plane of the compressor; and
a gas turbine controller controlling a firing temperature of the combustor based on the mass flow rate.

16. The gas turbine system of claim 15, wherein the first static pressure sensor includes a plurality of sensors that are substantially non-uniformly arranged about the plane of the plenum.

17. The gas turbine system of claim 15, wherein the first static pressure sensor includes a plurality of sensors and a position of each of the plurality of sensors about the plane of the plenum is based on a computational fluid dynamic simulation.

18. The gas turbine system of claim 15, wherein the first static pressure sensor includes a plurality of sensors and each sensor includes a differential type sensor.

19. The gas turbine system of claim 15, wherein the compressor further includes an inlet guide vane, and the entrance plane of the compressor is substantially aligned with an entrance plane of the inlet guide vane.

20. The gas turbine system of claim 15, wherein the mass flow rate is calculated according to the following equation:
Q=K(R_{ed})*Aₚₗₑₙᵤₘ*\sqrt{2ρΔP},
where Q is the mass flow rate, K (R_{ed}) is a calibrated flow coefficient as a function of Reynolds number, ρ is air density, ΔP is static pressure differential of the plane of the plenum and the entrance plane of the inlet guide vane, and Aₚₗₑₙᵤₘ is area of the plane of the plenum.
